(19) United States
(12) Patent Application Publication
(10) Pub. No.: US 2024/0415351 A1
(43) Pub. Date: Dec. 19, 2024

(54) Connecting tube for a hand-held, portable work apparatus

(71) Applicant: Andreas Stihl AG & Co. KG, Waiblingen (DE)

(72) Inventors: Kai Freckmann, Stuttgart (DE); Sebastian Junker, Ludwigsburg (DE); Lars Robert Kraft, Ludwigsburg (DE); Markus Oesterle, Althütte (DE); Jonathan Seiz, Stuttgart (DE)

(73) Assignee: Andreas Stihl AG & Co. KG, Waiblingen (DE)

(21) Appl. No.: 18/742,138

(22) Filed: Jun. 13, 2024

(30) Foreign Application Priority Data
Jun. 15, 2023 (DE) 10 2023 115 664.0

(51) Int. Cl. A47L 9/24; A47L 9/14; F16L 43/02

(52) U.S. Cl. CPC A47L 9/248; A47L 9/14; F16L 43/02

(57) ABSTRACT

A connecting tube guides an air flow from a blower of a handheld work apparatus to a catcher bag. The connecting tube is curved in an arcuate manner in a plane of curvature and has an inlet opening and an outlet opening. The air flow in the connecting tube is deflected in the plane of curvature along a longitudinal center line by at least 70°. The connecting tube has flow cross-sections oriented perpendicular to the longitudinal center line, each having an inner height measured perpendicular to the plane of curvature. The connecting tube has a center flow cross-section oriented perpendicular to the longitudinal center line halfway between the inlet opening and the outlet opening. Each flow cross-section has an inner width in the direction perpendicular to its inner height. The inner height of the center flow cross-section is greater than the inner width of the center flow cross-section.

### CROSS-REFERENCE TO RELATED APPLICATION

This application claims the benefit of German Patent Application DE 10 2023 115 664.0, filed on Jun. 15, 2023, the content of which is incorporated in its entirety.

### BACKGROUND

The application relates to a connecting tube for guiding an air flow from a blower of a handheld, portable work apparatus to a component, in particular to a catcher bag of the handheld, portable work apparatus.

The catcher bag of such a handheld, portable work apparatus, in particular a suction apparatus, is usually connected to the blower of the handheld, portable work apparatus by such a connecting tube, which is also referred to as an elbow. The arcuate curvature of the connecting tube in a plane of curvature allows an ergonomic arrangement of the catcher bag and an ergonomic carrying of the hand-held work apparatus.

For larger blower outputs and larger desired throughput through the connecting tube, the smallest flow cross-section of the connecting tube must be selected to be large. Typically, the connecting tube has an inlet opening and an outlet opening for the air flow. The outlet opening and the inlet opening are oriented relative to each other such that the air flow in the connecting tube is deflected in the plane of curvature by at least 70°, in particular by at least 80°. The connecting tube has a longitudinal center line. Along the longitudinal center line, the connecting tube has flow cross-sections oriented perpendicular to the longitudinal center line. Each flow cross-section has an internal height measured perpendicular to the plane of curvature. To enable a larger flow rate for the air flowing through the connecting tube, the smallest of these flow cross-sections must be selected to be large. From a certain minimum size for the smallest flow cross-section, the blower is accessible to a user from the outlet opening of the connecting tube, despite the curvature of the connecting tube.

### SUMMARY

The present disclosure provides an improved connecting tube for guiding an air flow from a blower of a handheld, portable work apparatus to a component, in particular to a catcher bag, of the handheld, portable work apparatus in such a way that even at a high flow rate for the air flow guided through the connecting tube, a safe and aerodynamically optimized use of the connecting tube is possible.

The connecting tube has a center flow cross-section oriented perpendicular to the longitudinal center line halfway between the inlet opening and the outlet opening along the longitudinal center line. Each flow cross-section oriented perpendicular to the longitudinal center line has an inner width in the direction perpendicular to its inner height. The inner height of the center flow cross-section is greater than the inner width of the center flow cross-section. This allows the center flow cross-section to have a large area and at the same time prevents someone from reaching through the connecting tube. The inner width of the center flow cross-section can be selected to be so small that a user cannot reach with their arm or with their hand from the outlet opening of the connecting tube through the connecting tube to the outlet opening. Even if the component, which can be designed as a catcher bag, is removed, the user is protected from accessing the blower.

Despite the small inner width of the center flow cross-section, the area of the center flow cross-section may be large due to a large inner height. This allows for a large flow of airflow. The connecting tube is at the same time safe, designed for a high blower output and designed to be aerodynamically favorable. The flow path of the air flow through the connecting tube can be designed without an additional component for access protection inside the connecting tube. This allows an undisturbed, turbulence-free guidance of the air flow in the connecting tube.

Advantageously, the inner height of the center flow cross-section is at least 120%, in particular at least 140%, in particular at least 160% of the inner width of the center flow cross-section.

Expediently, the center flow cross-section of the connecting tube has an oval shape. In particular, the center flow cross-section of the connecting tube has an elliptical shape. As a result, the connecting tube can be produced in a simple manner. Due to the oval, in particular elliptical, shape of the center flow cross-section, the connecting tube can be designed to be particularly stable. Due to the oval, in particular elliptical, shape of the center flow cross-section, good flow conditions are created inside the connecting tube. In particular, flow separation is prevented.

In an advantageous configuration the area of the flow cross-sections of the connecting tube increases in the direction from the inlet opening to the outlet opening along the longitudinal center line. In particular, it is provided that the area of the flow cross-sections of the connecting tube increases continuously in the direction from the inlet opening to the outlet opening along the longitudinal center line. Due to the increase in the area of the flow cross-sections, the flow velocity of the air flowing through the connecting tube decreases in the direction of the outlet opening of the connecting tube. Particles that are conveyed by the air flow through the connecting tube from the inlet opening to the outlet opening then reach the component connected to the connecting tube, in particular the catcher bag connected to the connecting tube, at a lower speed. The particles can thus be collected in the catcher bag without being unnecessarily disrupted by the incoming air flow. Due to the lower flow velocity of the air flow, the service life of the catcher bag is increased.

Expediently, the inner width of the center flow cross-section is from 90% to 110%, in particular at most 105%, in particular at most 100%, of the inner width of the flow cross-section at the inlet opening.

In particular, the inner width of the center flow cross-section is from 60% to 80%, in particular at most 70%, in particular at most 65%, of the inner width of the flow cross-section of the outlet opening.

Expediently, the inner height of the center flow cross-section is at least 110%, in particular at least 130%, in particular at least 150%, of the inner height of the flow cross-section of the inlet opening. As a result, the area of the center flow cross-section can also be increased when the inner width of the center flow cross-section is reduced compared to the inner width of the flow cross-section at the outlet opening.

Expediently, the inner height of the center flow cross-section is from 90% to 110%, in particular from 95% to 105%, in particular less than 100% of the inner height of the flow cross-section of the outlet opening.

Advantageously, the flow cross-section of the inlet opening of the connecting tube is circular. This makes it easy to manufacture the connecting tube. The circular shape of the flow cross-section of the inlet opening allows easy connection of the connecting tube to the blower of a handheld, portable work apparatus.

The connecting tube has a tangential plane. The tangential plane is perpendicular to the plane of curvature. In particular, the tangential plane is tangent to the inlet opening at a first contact point and at the same time tangent to the outlet opening at a second contact point. In particular, the tangential plane does not intersect any of the flow cross-sections of the connecting tube. The tangential plane advantageously only touches, but does not intersect, the entirety of the flow cross-sections.

The first contact point of the inlet opening is spaced at a point distance from the second contact point of the outlet opening. Each flow cross-section of the connecting tube has a plane distance to the tangential plane measured perpendicular to the tangential plane. The plane distance of a single flow cross-section can also be zero. This applies in particular to the flow cross-sections that are tangent to the tangential plane.

In an advantageous development, a largest plane distance of all plane distances of the flow cross-sections is at least 25%, in particular at least 30%, expediently at least 35% of the point distance. As a result, the connecting tube is more curved than an arc of a circle. For a 90° circular arc, the ratio of a corresponding plane distance to a corresponding point distance is approximately 20%. The fact that this ratio for the connecting tube is at least 25%, in particular at least 30%, in particular at least 35%, provides effective access protection.

The connecting tube has a radius of curvature in the plane of curvature at the center flow cross-section on the more curved side of the connecting tube.

Advantageously, the radius of curvature is less than 50%, expediently less than 40%, in particular less than 30%, of the point distance. This curvature enables reliable access protection. The curvature prevents a user from reaching from the outlet opening of the connecting tube to the inlet opening of the connecting tube with his arm or hand.

Advantageously, the connecting tube does not require a security bar for access protection. This lack of a security bar can prevent the formation of turbulence in the air flow. This avoids any negative influence on the air flow. By omitting a security bar for access protection, the noise emission of the connecting tube can be reduced.

The outlet opening has an outlet edge. In an advantageous configuration the outlet edge has at least one projection that protrudes in the direction of the longitudinal center line. In particular, the projection protrudes from a base body of the connecting tube in the direction of the longitudinal center line. Due to the projection, the noise emission caused by the air flow emerging from the outlet opening of the connecting tube is reduced. Because a portion of the air flow accelerated by the blower can exit from the connecting tube at a point of the outlet edge that is arranged closer to the inlet opening along the longitudinal center line than the end of the projection furthest away from the inlet opening along the longitudinal center line, the air mass compressed by the blower does not expand at once. Part of the compressed air mass only exits the connecting tube at the end of the projection. The exit of the air mass/air flow from the connecting tube is distributed over a projection height of the projection measured along the longitudinal center line. This results in a reduction in noise emissions.

The projection has a projection height. The projection height is measured in the direction of the longitudinal center line. The projection height is measured from the base body of the connecting tube. Advantageously, the projection height is at least 20%, in particular at least 30%, in particular at least 40%, of the inner width of the flow cross-section of the outlet opening of the connecting tube. This allows the pressure of the air flow to be reduced over a sufficiently long distance as it exits the outlet opening of the connecting tube.

Expediently, the outlet edge has a plurality of projections. In particular, the outlet edge is wavy due to the plurality of projections. Such patterns are known as chevrons on the trailing edges of aircraft nozzles. Such sawtooth-shaped patterns lead to better mixing of air currents of different speeds. The pattern does not have to be strictly sawtooth-shaped. It can also be provided that the tips of the saw teeth are rounded.

An exemplary embodiment of the invention is explained below with reference to the drawing.

### BRIEF DESCRIPTION OF THE DRAWINGS

FIG. 1 shows a perspective view of a handheld, portable work apparatus designed as a suction apparatus, with a connecting tube for guiding an air flow from a blower of the work apparatus to a component of the handheld work apparatus designed as a catcher bag.

FIGS. 2 to 5 show perspective views of the connecting tube of FIG. 1.

FIG. 6 is a sectional view of a section through the connecting tube of FIGS. 2 to 5 along the plane of curvature of the connecting tube.

FIG. 7 is a sectional view of a section along the sectional plane VII-VII drawn in FIG. 6.

FIG. 8 is a sectional view of a section along the sectional plane VIII-VIII drawn in FIG. 6.

FIG. 9 is a sectional view of a section along the sectional plane IX-IX drawn in FIG. 6.

FIG. 10 is a top view of the connecting tube of FIGS. 2 to 9 in a direction perpendicular to the plane of curvature of the connecting tube.

### DETAILED DESCRIPTION

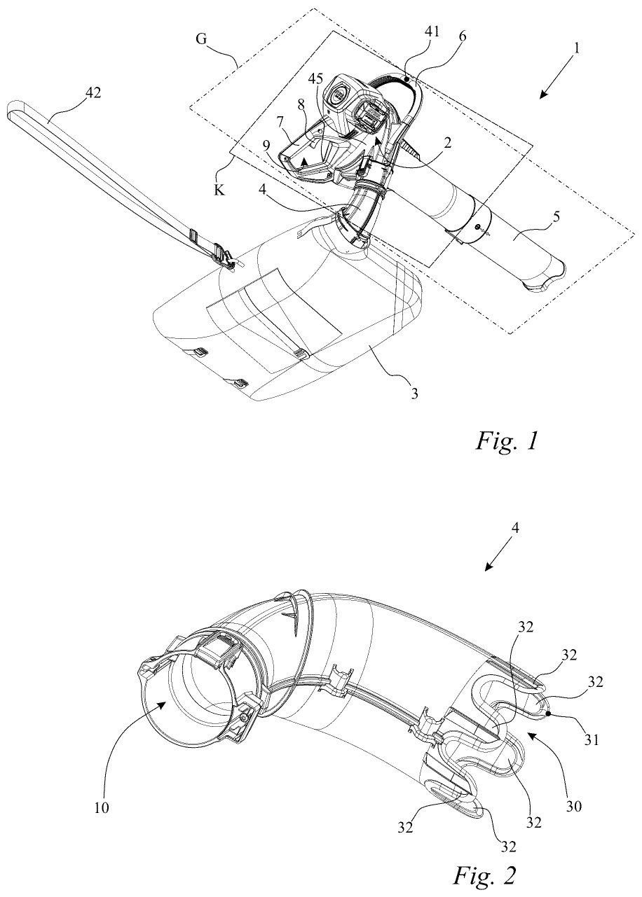

FIG. 1 shows a work apparatus 1. The work apparatus 1 is a hand-held, portable work apparatus. In the exemplary embodiment, the work apparatus 1 is a suction apparatus. However, the work apparatus may also be a suction/blowing apparatus. The work apparatus can also be another handheld work apparatus, in which a blower conveys an air flow to a component (such as a catcher bag).

In the exemplary embodiment, the work apparatus 1 comprises a blower 2. The work apparatus 1 comprises a component 3. In the exemplary embodiment, the component 3 is designed as a catcher bag. The work apparatus 1 comprises a connecting tube 4. The connecting tube 4 connects the blower 2 to the component 3. The connecting tube 4 is used to guide an air flow from the blower 2 to the component 3. The blower 2 conveys air through the connecting tube 4 into the component 3 designed as a catcher bag.

The work apparatus 1 has a suction tube 5 in fluid communication with the blower 2. The blower 2 generates an air flow that is sucked in through the suction tube 5. Objects to be sucked in during use of the work apparatus 1, such as leaves or clippings, are sucked in with the air flow and conveyed via the blower 2 through the connecting tube 4 into the catcher bag. The work apparatus 1 comprises a handlebar 6. The work apparatus 1 comprises a control handle 7. The control handle 7 is formed separately from the handlebar 6. The handlebar 6 is used to carry and guide the work apparatus 1 during use of the work apparatus 1. The control handle 7 is used to guide and operate the work apparatus 1 when using the work apparatus 1. A control element 8 is provided on the control handle 7. The control element 8 can be used to control the power of a motor (not shown). In the exemplary embodiment, the motor is an electric motor. However, it can also be an internal combustion engine. The motor drives the blower 2.

In the exemplary embodiment, the control handle 7 delimits a handle opening 9. The operator can reach through the handle opening 9 and thus grasp the control handle 7. The handle opening 9 extends in a handle plane G. A holding area 41 of the handlebar 6 extends transversely, in the embodiment perpendicular, to the handle plane G of the handle opening 9.

The connecting tube 4 is also arranged on one side of the handle plane G of the handle opening 9. The connecting tube 4 is arranged on the end of the suction tube 5 facing away from an inlet opening 10 of the suction tube 5. The connecting tube 4 is arranged in the area of the blower 2. The connecting tube 4 is arranged between the control handle 7 and the suction tube 5. The connecting tube 4 is attached to a housing of the work apparatus 1. The housing has a housing opening (not shown). The housing opening completely penetrates a wall 45 of the housing that delimits the housing to the outside. The housing opening serves to guide the air flow generated by the blower from the interior of the housing to the outside of the housing/to the component 3 designed as a catcher bag. The connecting tube 4 is arranged on the housing opening. The connecting tube 4 covers the housing opening. The connecting tube 4 is connected to the housing in an airtight manner. The connecting tube 4 is tubular. An outer wall 43 of the connecting tube 4 encloses an interior of the connecting tube 4. The outer wall 43 of the connecting tube 4 includes the inlet opening 10 and the outlet opening 30 as openings to the interior.

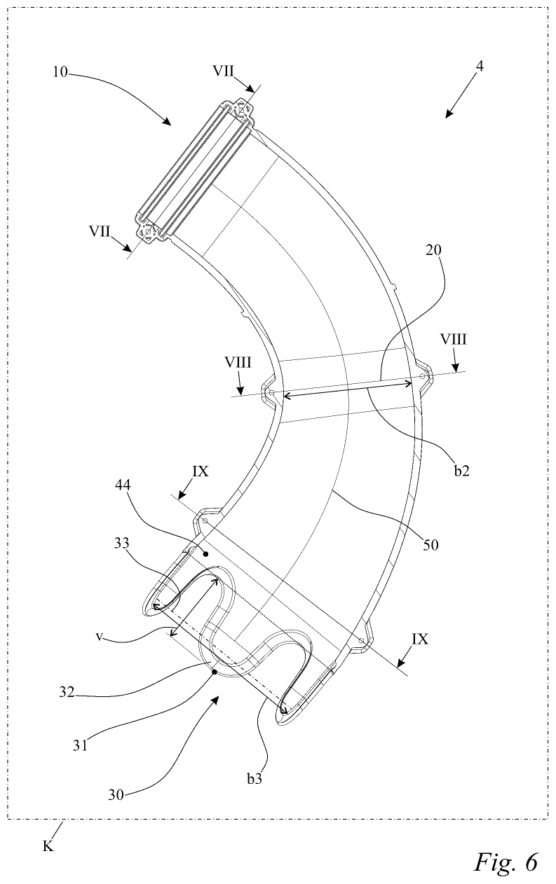

As shown in FIG. 2, the connecting tube 4 is curved in an arcuate shape. The connecting tube 4 is curved in an arcuate shape in a plane of curvature K, which is also shown in FIG. 6. The plane of curvature K is shown in FIG. 1. The plane of curvature K runs transversely to the handle plane G. In the exemplary embodiment, the plane of curvature K runs perpendicularly to the handle plane G. As can be seen in FIG. 1, the component 3 designed as a catcher bag can be arranged next to the blower 2 due to the arcuate curvature of the connecting tube 4. The catcher bag can be arranged at a distance from the suction tube 5 by the side of the suction tube 5. Due to the curvature of the connecting tube 4, the catcher bag can be arranged in a plane that runs parallel to the handle plane G. Due to the arcuate curvature of the connecting tube 4, the work apparatus 1 is ergonomically designed. During use, the operator can hold the work apparatus 1 by the handlebar 6, operate it with the control handle 7, and at the same time place the component 3 designed as a catcher bag next to the operator and carry it with a carrying strap 42 shown in FIG. 1. Due to the arcuate curvature of the connecting tube 4, the objects to be sucked in can be deflected downward by the blower 2 when the work apparatus 1 is in use. In this way, the sucked-in objects can be easily collected in the component 3 designed as a catcher bag by utilizing gravity. Due to the arcuate curvature of the connecting tube 4, the air flow is slowed down on its way to the component 3 designed as a catcher bag. This reduces turbulence in the catcher bag and increases the service life of the catcher bag.

The connecting tube 4 is also referred to as an elbow. As shown in FIG. 2, the connecting tube 4 has an inlet opening 10. The inlet opening 10 serves to allow the air flow to enter the connecting tube 4. The connecting tube 4 has an outlet opening 30. The air flow can exit the connecting tube 4 through the outlet opening 30. In the exemplary embodiment, the connecting tube is arranged in the work apparatus 1 with the inlet opening 10 near the blower 2. The end of the connecting tube 4 with the outlet opening 30 points away from the blower 2. The outlet opening 30 of the connecting tube 4 is connected to the component 3 designed as a catcher bag. The air flow enters the component 3 designed as a catcher bag through the outlet opening 30.

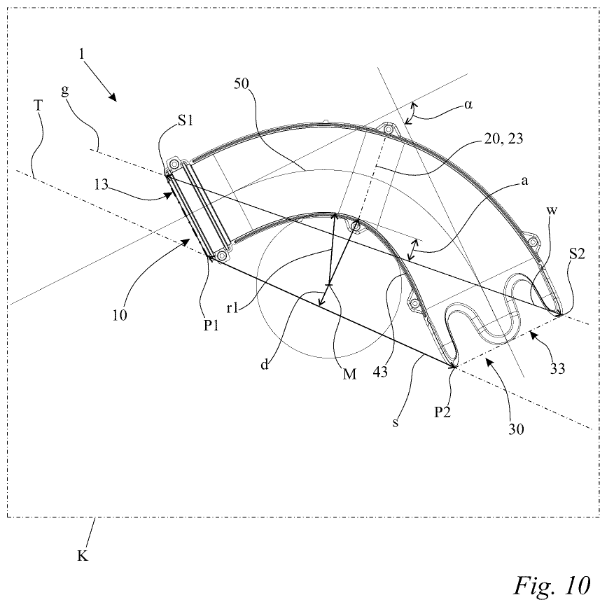

The outlet opening 30 and the inlet opening 10 are oriented relative to each other such that the air flow in the connecting tube 4 is deflected in the plane of curvature K by a deflection angle α of at least 70°, in the exemplary embodiment of at least 80°, as illustrated in FIG. 10. In the exemplary embodiment, the deflection angle α is approximately 90°. In particular, the deflection angle α is exactly 90°. In the exemplary embodiment, the deflection angle α is at most 120°, in particular at most 110°. Between the inlet opening 10 and the outlet opening 30 the air flow changes direction along a single arc. Starting from the inlet opening 10, the air flow changes direction, due to the guidance through the connecting tube 4, in only one direction and only towards the outlet opening 10.

As shown in FIG. 10, the connecting tube 4 has a longitudinal center line 50. Along the longitudinal center line 50, the air flow is conveyed from the inlet opening 10 through the connecting tube 4 to the outlet opening 30. The longitudinal center line 50 is curved in an arc shape. The longitudinal center line 50 runs through the centroids of the flow cross-sections of the connecting tube 4. The plane of curvature K contains the longitudinal center line 50. The longitudinal center line 50 is also referred to as the longitudinal center axis, centroidal line, or centroidal axis. The longitudinal center line 50 has a length of at most 850 mm measured along the curved longitudinal center line 50 from the inlet opening 10 to the outlet opening 30. The length of the longitudinal center line 50 is expediently determined by a path integral along the longitudinal center line 50 from the inlet opening 10 to the outlet opening 30.

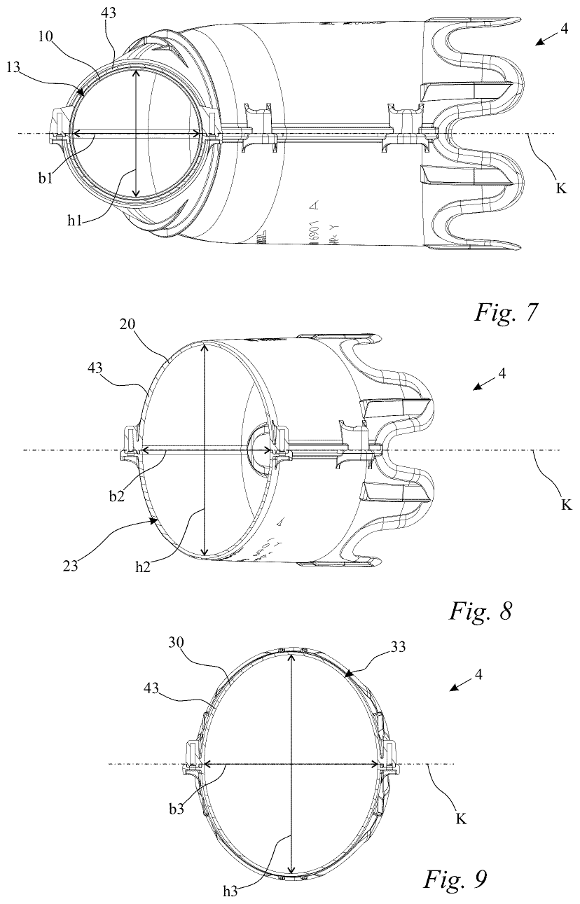

The connecting tube 4 has flow cross-sections oriented along the longitudinal center line 50 perpendicular to the longitudinal center line 50. The flow cross-sections 13, 23 and 33 are illustrated by way of example in FIGS. 7 to 9. The outer wall 43 of the connecting tube delimits the flow cross-sections 13, 23, 33. Each flow cross-section 13, 23, 33 has an internal height h1, h2, h3 measured perpendicular to the plane of curvature K. The flow cross-section 13 of the inlet opening 10 shown in FIG. 7 has the inner height h1. The flow cross-section 23 shown in FIG. 8 has the inner height h2. The flow cross-section 33 of the outlet opening 30 shown in FIG. 9 has the inner height h3. The flow cross-section 23 shown in FIG. 8 is also referred to as the center flow cross-section 20. The center flow cross-section 20 is oriented perpendicular to the longitudinal center line 50. The center flow cross-section 20 is arranged along the longitudinal center line 50 halfway between the inlet opening 10 and the outlet opening 30. The center flow cross-section 20 has the inner height h2. The inner heights h1, h2, h3 are in each case the largest extent of the associated flow cross-section 13, 23, 33 measured in a direction perpendicular to the plane of curvature K.

The longitudinal center line 50 has an integrated length in the area between the inlet opening 10 and the outlet opening 30. The center flow cross-section 20 divides the distance associated with this length into two equally long pieces.

Each flow cross-section oriented perpendicular to the longitudinal center line 50 has an inner width. The inner width is measured parallel to the plane of curvature K. In the exemplary embodiment, the inner width is measured in the plane of curvature K. The inner width is measured in a direction perpendicular to the inner height. In the direction parallel to the plane of curvature K, the inner width is the largest dimension of the associated flow cross-section. The inner widths b1, b2 and b3 are illustrated by way of example in FIGS. 7, 8 and 9. The inner width b1 is assigned to the flow cross-section 13 of the inlet opening 10 (FIG. 7). As shown in FIG. 8, the inner width b2 is assigned to the flow cross-section 23, in the exemplary embodiment to the center flow cross-section 20. As shown in FIG. 9, the inner width b3 is the width of the flow cross-section 33 of the outlet opening 30. The inner height h1 is perpendicular to the inner width b1. The inner height h2 is perpendicular to the inner width b2. The inner height h3 is perpendicular to the inner width b3.

The inner height h2 of the center flow cross-section 20 is greater than the inner width b2 of the center flow cross-section 20 (FIG. 8). The inner height h2 of the center flow cross-section 20 is at least 120%, in particular at least 140%, in the exemplary embodiment at least 160% of the inner width b2 of the center flow cross-section 20.

The inner height h2 of the center flow cross-section 20 is in particular at most 200%, in particular at most 190%, in the exemplary embodiment at most 180% of the inner width b2 of the center flow cross-section.

The center flow cross-section 20 of the connecting tube 4 has an oval shape. In the exemplary embodiment, the center flow cross-section 20 of the connecting tube 4 has an elliptical shape. In particular, the shape of the center flow cross-section 20 deviates from the circular shape.

The inner height of each individual flow cross-section from the set of flow cross-sections of the connecting tube 4 along the longitudinal center line 50 starting from the outlet opening 30 in the direction of the inlet opening 10 over at least 60%, in particular over at least 70%, in the exemplary embodiment over at least 80%, of the distance of the longitudinal center line 50 between the inlet opening 10 and the outlet opening 30 is advantageously greater than the inner width belonging to the individual flow cross-section.

The individual flow cross-sections from the set of flow cross-sections of the connecting tube 4 along the longitudinal center line 50 starting from the outlet opening 30 in the direction of the inlet opening 10 over at least 60%, in particular over at least 70%, in the exemplary embodiment over at least 80%, of the distance of the longitudinal center line 50 between the inlet opening 10 and the outlet opening 30 each have an oval shape, in the exemplary embodiment an elliptical shape.

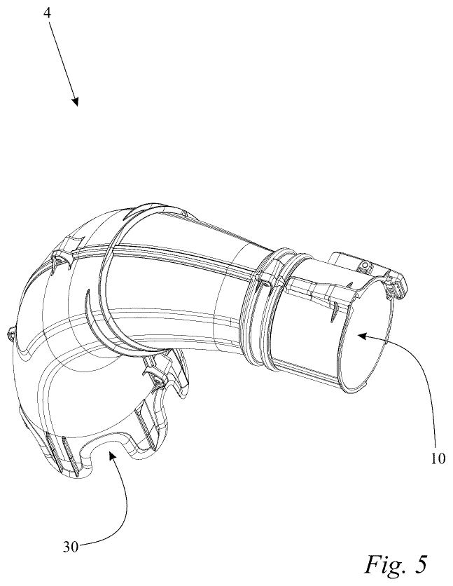

As can be seen from the combination of FIGS. 2 to 6, the area of the flow cross-sections of the connecting tube 4 increases in the direction from the inlet opening 10 to the outlet opening 30 along the longitudinal center line 50. This is illustrated by way of example in FIGS. 7 to 9 for the flow cross-sections 13, 23 and 33 at the inlet opening 10, in the middle of the connecting tube 4 halfway along the longitudinal center line 50, and at the outlet opening 30. In the exemplary embodiment, the area of the flow cross-sections 13, 23, 33 of the connecting tube 4 increases continuously in the direction from the inlet opening 10 to the outlet opening 30 along the longitudinal center line 50.

The inner width b2 of the center flow cross-section 20 is from 90% to 110%, in particular at most 100% of the inner width b1 of the flow cross-section 13 of the inlet opening 10.

The inner width b2 of the center flow cross-section 20 is from 60% to 80% of the inner width b3 of the flow cross-section 33 of the outlet opening 30. As can also be seen from FIG. 6, the inner width b2 of the center flow cross-section 20 is the smallest inner width of the connecting tube 4, in particular of all flow cross-sections of the connecting tube 4.

The inner height h2 of the center flow cross-section 20 shown in FIG. 8 is at least 110%, in particular at least 130%, in the exemplary embodiment at least 150%, of the inner height h1 of the flow cross-section 13 of the inlet opening 10 shown in FIG. 7.

The inner height h2 of the center flow cross-section 20 is from 90% to 110%, in particular from 95% to 105%, in the exemplary embodiment less than 100% of the inner height h3 of the flow cross-section 33 of the outlet opening 30. In the exemplary embodiment, the inner height of the connecting tube 4, in particular of all flow cross-sections of the connecting tube 4, increases from the inlet opening 10 along the longitudinal center line 50 to the outlet opening 30, in particular continuously.

As shown in FIG. 7, the flow cross-section 13 of the inlet opening 10 of the connecting tube 4 is circular.

In the exemplary embodiment, the inner height h1 of the flow cross-section 13 of the inlet opening 10 is from 25 mm to 135 mm, in particular from 45 mm to 115 mm, in particular from 55 mm to 105 mm.

In the exemplary embodiment, the inner width b1 of the flow cross-section 13 of the inlet opening 10 is from 25 mm to 135 mm, in particular from 45 mm to 115 mm, in particular from 55 mm to 105 mm.

In the exemplary embodiment, the inner height h2 of the center flow cross-section 20 is from 90 mm to 190 mm, in particular from 110 mm to 170 mm, in particular from 120 mm to 160 mm.

In the exemplary embodiment, the inner width b2 of the center flow cross-section 20 is from 25 mm to 135 mm, in particular from 45 mm to 115 mm, in particular from 55 mm to 105 mm.

In the exemplary embodiment, the inner height h3 of the flow cross-section 33 of the outlet opening 30 is from 100 mm to 200 mm, in particular from 120 mm to 180 mm, in particular from 130 mm to 170 mm.

In the exemplary embodiment, the inner width b3 of the flow cross-section 33 of the outlet opening 30 is from 70 mm to 170 mm, in particular from 90 mm to 150 mm, in particular from 100 mm to 140 mm.

As shown in FIG. 10, the connecting tube 4 has a tangential plane T. The tangential plane T runs perpendicular to the plane of curvature K. The tangential plane T is tangent to the inlet opening 10 at a first contact point P1 and at the same time to the outlet opening 30 at a second contact point P2. The tangential plane T intersects neither the outlet opening 30 nor the inlet opening 10. The tangential plane T merely touches the flow cross-sections of the connecting tube 4. None of the flow cross-sections of the connecting tube 4 is intersected by the tangential plane T. The tangential plane T borders in particular on the flow cross-section 13 of the inlet opening 10 and at the same time on the flow cross-section 33 of the outlet opening 30. Neither the flow cross-section 13 of the inlet opening 10 nor the flow cross-section 33 of the outlet opening 30 is intersected by the tangential plane T. The tangential plane T lies on the more curved side of the connecting tube 4.

The first contact point P1 is on the edge of the inlet opening 10. The first contact point P1 is on the edge of the flow cross-section 13 of the inlet opening 10. The second contact point P2 is on the edge of the outlet opening 30. The second contact point P2 is on the edge of the flow cross-section 33 of the outlet opening 30.

The first contact point P1 is at a point distance s from the second contact point P2. In the exemplary embodiment, both the first contact point P1 and the second contact point P2 are in the plane of curvature K. The point distance s is measured in the plane of curvature K.

Each flow cross-section of the connecting tube 4 has a plane distance to the tangential plane T measured perpendicular to the tangential plane T. By way of example, FIG. 10 shows the flow cross-sections 13, 23 and 33 of the connecting tube 4, which each have a plane distance from the tangential plane T. For the flow cross-section 13 of the inlet opening 10, the plane distance is zero. Likewise, the plane distance for the flow cross-section 33 of the outlet opening 30 is zero.

The set of all plane distances includes a largest plane distance d. In the exemplary embodiment, the largest plane distance d is at the location of the center flow cross-section 20. The plane distance of the center flow cross-section 20 is the largest plane distance d of all plane distances. Of all flow cross-sections of the connecting tube 4, the center flow cross-section 20 has the largest plane distance, namely the largest plane distance d. The largest plane distance d is at least 25%, in particular at least 30%, in the exemplary embodiment at least 35% of the point distance s. This prevents a user from reaching the inlet opening 10 of the connecting tube from the outlet opening 30 through the connecting tube 4 with a hand or an arm. Due to the substantial largest plane distance d, the (direct) path from the outlet opening 30 through the connecting tube 4 to the inlet opening 10 is narrowed or curved such that a user cannot reach through with his hand or arm. Bending the hand or arm to such an extent is not possible.

In particular, the largest plane distance d is at most 70%, in particular at most 60%, in the exemplary embodiment at most 50% of the point distance s.

As shown in FIG. 10, the connecting tube 4 has a radius of curvature r1 on its more curved side in the plane of curvature K at the center flow cross-section 20. The more curved side of the connecting tube 4 is also referred to as the side of the inner curvature. The radius of curvature r1 is less than 50%, in particular less than 40%, in the exemplary embodiment less than 30% of the point distance s. The radius of curvature r1 at the center flow cross-section 20 is a measure of the curvature of the more curved side of the connecting tube 4 in the plane of curvature K. The smaller the radius of curvature, the greater the curvature.

Due to the small ratio of radius of curvature r1 to point distance s, the curvature at the center flow cross-section 20 is large. The strong curvature of the connecting tube 4 provides access protection. The strong curvature prevents a user from reaching with his hand or arm from the outlet opening 30 through the connecting tube 4 to the inlet opening 10.

This access protection is also provided, even without the connecting tube 4 having a security bar for access protection.

In the exemplary embodiment, the radius of curvature r1 is greater than 10%, in particular greater than 20%, of the point distance s.

As shown in FIG. 10, an edge of the inlet opening 10 in the plane of curvature K has a first secant point S1 located on the outside with respect to the curvature of the connecting tube 4. The first secant point S1 is in the plane of curvature K. The first secant point S1 is at the edge of the flow cross-section 13 of the inlet opening 10.

The edge of the outlet opening 30 has a second secant point S2 on the side located on the outside in the plane of curvature K with respect to the curvature of the connecting tube 4. The second secant point S2 is in the plane of curvature K. The second secant point S2 is at the edge of the flow cross-section 33 of the outlet opening 30.

A straight line g runs through the first secant point S1 and the second secant point S2. The straight line g runs along a direct connecting line between the outlet opening 30 and the inlet opening 10.

The connecting tube 4 has the outer wall 43. The straight line g intersects the outer wall 43. In particular, the straight line g intersects the outer wall 43 in the area of the outer wall 43 that lies on the more curved side of the connecting tube 4. The center flow cross-section 20 is arranged at a perpendicular distance a from the straight line g measured perpendicular to the straight line g. The perpendicular distance a is at least 1%, in particular at least 3%, expediently at least 5%, in the exemplary embodiment at least 7% of the point distance s. The second secant point S2 is arranged at a secant point distance w from the first secant point S1. In the exemplary embodiment, the secant point distance w is measured in the plane of curvature K. The perpendicular distance a is at least 1%, in particular at least 3%, in the exemplary embodiment at least 5% of the secant point distance w. In the exemplary embodiment, the perpendicular distance a is at most 50%, in particular at most 30%, expediently at most 15% of the secant point distance w.

Because the straight line g intersects the outer wall 43 of the connecting tube 4, it is not possible to reach through the connecting tube 4 on a straight, direct path from the outlet opening 30 to the inlet opening 10. During such an attempt, an operator hits the inside of the outer wall 43. The inner side of the outer wall 43 delimits all flow cross-sections of the connecting tube 4.

As shown in FIG. 6, the outlet opening 30 has an outlet edge 31. The outlet edge 31 has at least one projection 32 in the direction of the longitudinal center line 50. The projection 32 protrudes relative to a base body 44 of the connecting tube 4. In FIG. 6, the imaginary separation between the base body 44 and the projection 32 is shown with a dashed line. The corresponding parting plane is perpendicular to the longitudinal center line 50.

The projection 32 has a projection height v. The projection height v is at least 20%, in particular at least 30%, in the exemplary embodiment at least 40% of the inner width b3 of the flow cross-section 33 of the outlet opening 30 of the connecting tube 4. The projection height v is measured in the direction of the longitudinal center line 50 at the outlet opening 30. The projection height v is measured from the parting plane between the base body 44 and the projection 32 in the direction of the projection 32. The projection height v is measured perpendicular to the parting plane between the base body 44 and the projection 32.

The outlet edge 31 has a plurality of projections 32. The outlet edge 31 is wavy due to the plurality of projections 32. Such a wavy pattern is also referred to as a chevron. Such patterns are known from jet engines of aircraft.

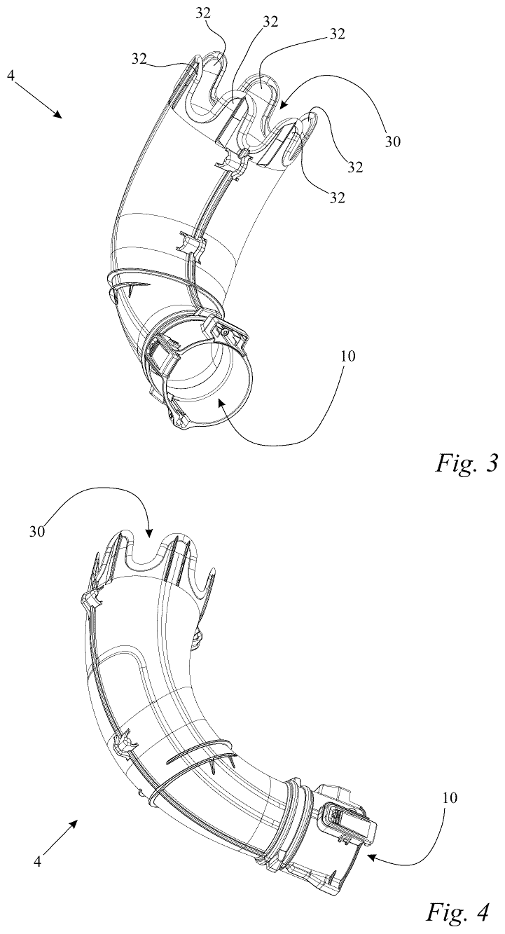

The outlet edge 31 extends completely around the longitudinal center line 50. As shown in FIGS. 2 and 3, a total of six projections 32 are provided in the exemplary embodiment. Due to the projections 32, the circumferential outlet edge 31 is designed in a wavy shape.

What is claimed is:

1. A connecting tube (4) for guiding an air flow from a blower (2) of a handheld, portable work apparatus (1) to a component (3) of the handheld, portable work apparatus (1),
wherein the connecting tube (4) is curved in an arcuate manner in a plane of curvature (K),
wherein the connecting tube (4) has an inlet opening (10) for the air flow,
wherein the connecting tube (4) has an outlet opening (30) for the air flow,
wherein the outlet opening (30) and the inlet opening (10) are oriented relative to each other such that the air flow in the connecting tube (4) is deflected in the plane of curvature (K) by at least 70°,
wherein the connecting tube (4) has flow cross-sections (13, 23, 33) oriented along a longitudinal center line (50) perpendicular to the longitudinal center line (50),
wherein each of the flow cross-sections (13, 23, 33) has an inner height (h1, h2, h3) measured perpendicular to the plane of curvature (K),
wherein the connecting tube (4) has a center flow cross-section (20) oriented perpendicular to the longitudinal center line (50) halfway between the inlet opening (10) and the outlet opening (30) along the longitudinal center line (50),
wherein each of the flow cross-sections (13, 23, 33) oriented perpendicular to the longitudinal center line (50) has an inner width (b1, b2, b3) perpendicular to its inner height (h1, h2, h3), and
wherein the inner height (h2) of the center flow cross-section (20) is greater than the inner width (b2) of the center flow cross-section (20).

2. The connecting tube according to claim 1,
wherein the inner height (h2) of the center flow cross-section (20) is at least 140% of the inner width (b2) of the center flow cross-section (20).

3. The connecting tube according to claim 1,
wherein the center flow cross-section (20) of the connecting tube (4) has an elliptical shape.

4. The connecting tube according to claim 1,
wherein an area of the flow cross-sections (13, 23, 33) increases from the inlet opening (10) towards the outlet opening (30) along the longitudinal center line (50).

5. The connecting tube according to claim 1,
wherein the inner width (b2) of the center flow cross-section (20) is from 90% to 110% of the inner width (b1) of an inlet flow cross-section (13) at the inlet opening (10).

6. The connecting tube according to claim 1,
wherein the inner width (b2) of the center flow cross-section (20) is from 60% to 80% of the inner width (b3) of an outlet flow cross-section (33) of the outlet opening (30).

7. The connecting tube according to claim 1,
wherein the inner height (h2) of the center flow cross-section (20) is at least 130% of the inner height (h1) of the flow cross-section (13) of the inlet opening (10).

8. The connecting tube according to claim 1,
wherein the inner height (h2) of the center flow cross-section (20) is from 95% to 105% of the inner height (h3) of the flow cross-section (33) of the outlet opening (30).

9. The connecting tube according to claim 1,
wherein the flow cross-section (13) of the inlet opening (10) of the connecting tube (4) is circular.

10. The connecting tube according to claim 1,
wherein the connecting tube (4) has a tangential plane (T) that runs perpendicular to the plane of curvature (K) and that touches the inlet opening (10) at a first contact point (P1) and the outlet opening (30) at a second contact point (P2),
wherein the first contact point (P1) has a point distance(s) from the second contact point (P2),
wherein each of the flow cross-sections (13, 23, 33) of the connecting tube (4) has a plane distance measured perpendicular to the tangential plane (T), and
wherein a largest plane distance (d) of all plane distances of the flow cross-sections (13, 23, 33) from the tangential plane (T) is at least 30% of the point distance(s).

11. The connecting tube according to claim 1,
wherein the connecting tube (4) has a tangential plane (T) that runs perpendicular to the plane of curvature (K) and that touches the inlet opening (10) at a first contact point (P1) and the outlet opening (30) at a second contact point (P2),
wherein the first contact point (P1) has a point distance(s) from the second contact point (P2),
wherein the connecting tube (4) has a radius of curvature (r1) in the plane of curvature (K) at the center flow cross-section (20) on a more curved side of the connecting tube (4), and
wherein the radius of curvature (r1) is less than 40% of the point distance(s).

12. The connecting tube according to claim 1,
wherein the connecting tube (4) does not include a security bar for access protection.

13. The connecting tube according to claim 1,
wherein the outlet opening (30) has an outlet edge (31), and
wherein the outlet edge (31) has a projection (32) in a direction of the longitudinal center line (50).

14. The connecting tube according to claim 13,
wherein the projection (32) has a projection height (v), and
wherein the projection height (v) is at least 30% of the inner width (b3) of the flow cross-section (33) of the outlet opening (30) of the connecting tube (4).

15. The connecting tube according to claim 13,
wherein the projection (32) is one of a plurality of projections (32), and
wherein the outlet edge (31) has a wavy shaped due to the plurality of projections (32).

16. A handheld, portable suction apparatus, comprising:
a blower (2);
a suction tube (5) in fluid connection with a suction inlet of the blower (2);
a catcher bag (3) in fluid connection with an outlet of the blower (2); and
the connecting tube (4) as in claim 1,
the inlet opening (10) being connected to the outlet of the blower (2), and
the outlet opening (30) being connected to the catcher bag.
